(19) United States
(12) Patent Application Publication
(10) Pub. No.: US 2025/0219251 A1
(43) Pub. Date: Jul. 3, 2025

(54) RECHARGEABLE BATTERIES EXHIBITING IMPROVED CYCLE-LIFE CHARACTERISTICS IN RELATION TO THE UTILIZATION OF WATER-SCAVENGING CELLULOSE-BASED SEPARATORS

(71) Applicant: Soteria Bettery Innovation Group, Inc., Greenville, SC (US)

(72) Inventors: Drew J. Pereira, St. Louis, MO (US); Brian G. Morin, Greenville, SC (US)

(21) Appl. No.: 18/401,347

(22) Filed: Dec. 30, 2023

(51) Int. Cl. H01M 50/489; H01M 10/0525; H01M 10/0569; H01M 50/429; H01M 50/44

(52) U.S. Cl. CPC H01M 50/489; H01M 10/0525; H01M 10/0569; H01M 50/4295; H01M 50/44; H01M 2300/0028

(57) ABSTRACT

Disclosed herein is a novel lithium-ion battery separator of a cellulose base exposed to a heat treatment within a specific range of temperatures and times subsequent to manufacture thereof. Such a separator exhibits an unexpected level of effective water scavenging within a lithium-ion battery cell without any compromise in separator capability in order to provide a simplified manner of mitigating hydrofluoric acid generation. Such a procedure protects transition metal cathode constituents from oxidation/dissolution which in turn leads to improvements in capacity retention within a subject lithium-ion battery.

### FIELD OF THE DISCLOSURE

Disclosed herein is a novel lithium-ion battery separator of a cellulose base exposed to a heat treatment within a specific range of temperatures and times subsequent to manufacture thereof. Such a separator exhibits an unexpected level of effective water scavenging within a lithium-ion battery cell without compromising any separator characteristics in order to provide a simplified manner of mitigating hydrofluoric acid generation. Such a procedure protects transition metal cathode constituents from oxidation/dissolution which in turn leads to improvements in capacity retention within a subject lithium-ion (or other type of rechargeable) battery.

### BACKGROUND OF THE PRIOR ART

Lithium-ion batteries have proven to be of enormous importance as the utilization of electrical devices, from phones to vehicles and further, has grown and continues to grow. In the transportation area, in particular, the capability of such lithium-based electrical generating batteries has led to more widespread adoption and utilization of electrical vehicles throughout the world. The high energy-density, durability, and reasonable cost of such lithium-ion batteries have contributed to such increased usage, certainly; however there remain significant concerns with such large-scale and, again, growing, lithium-ion battery technology. For example, material sourcing is a consistent issue, namely the availability and costs associated with lithium-ion devices (lithium in general, at least, not to mention other electrolyte and metal components), particularly with the expected steady industry growth expected in the future. Additionally, the ability to recycle such batteries is not a simple task, even though the reclamation of lithium-based materials may help in the future. Disposal of such batteries is also problematic as environmental concerns with landfill run-off, leaching, etc., into ground water, as an example, not to mention the lack of biodegradable materials within such battery articles, are of significant concern. As such, the benefits accorded such electrical device industries by lithium-ion battery (and other power generator) technologies necessitate improvements to best ensure effective utilization with reduced disposal/recycling requirements. Optimizing long-term lithium-ion battery device usage would be of great help in this area. To date, such life cycle improvements have focused on highly complex and costly modifications. A simpler, more reliable approach would be beneficial, certainly, but there is nothing viable to date within the pertinent industries. There thus exists a significant need for such a simplified and cost-effective focus on increasing the useful life of such lithium-ion batteries (particularly within electrical vehicles) to reduce waste and consider alternative battery materials.

The primary efforts directed at lithium-battery improvements have centered on, as noted above, more complex and costly activities with limited success. For example, it has been determined that the utilization of certain lithium-based electrolytes, particularly including hexafluorophosphate groups therein, are subject to reaction with free water within a battery to form hydrofluoric acid. Such an oxidizing agent has shown a propensity to oxidize and dissolve certain transition metals present within a cathode component (at least). The structural resiliency of such a subject battery relies greatly upon the stability of such a cathode and the ability for the cell to properly function (charging and discharging). A reduction in transition metal presence within such a cell appears to result in reduced operation, at least to the extent of capacity compromise and shortening over time (cycle life). As such, it has been realized that HF generation and subsequent scavenging thereof within a closed lithium-ion cell may provide significant benefits in structural stability of the cathode component. Such HF scavenging is possible, certainly, but the initial presence of HF within such a cell allows for undesirable oxidation to occur and thus requires post-HF production reactions rather than prevention of generation itself. Such HF scavenging possibilities basically require reliance upon not only such acid-scavenging reactions but, further, the understanding that any remaining water within the closed cell may hydrolyze the fluorine source electrolyte and create more HF over time as well.

Thus, rather than focusing on HF scavenging alone, the potential to reduce water content during lithium-ion cell assembly has become a priority within the industry. Notably, even small amounts of water within the cell and/or within the electrolyte itself (on the scale of ˜20 ppm, as one example) have contributed to significant HF production therein, to the effect that even such a small amount of HF generated thereby has been shown to significantly accelerate transition metal loss within the subject cathode (at least). Additionally, it should be noted that hydrolysis of such an electrolyte will also result in a reduction in full electrolyte present, compromising the full lithium-ion battery power production capabilities. Coupled with the HF oxidation of the transition metal components within the cell, again, the life cycle of such a power generation device may be significantly affected. Unfortunately, reaction of the HF with the transition-metal-based cathode can also create additional water, subsequently creating a circular reaction path that can lead to significant degradation of the cathode. Furthermore, byproducts from the reaction of water with the electrolyte and then the HF oxidation reaction with metal may contribute deleteriously as well to reduced reactions at the anode SEI. Specifically, the transformation of organic to inorganic species at the anode SEI can deteriorate its initial structure and increase its thickness, leading to increased ionic resistance and reduced quantity of accessible lithium at the surface thereof, at least. Such a seemingly “domino effect” in relation to water presence, particularly the resultant detrimental effects at both the anode and cathode caused thereby, ultimately, again, the need and thus capability of controlling and/or removing even small traces of water within a manufactured (and sealed) cell has been a significant concern within the industry. Such free water exists environmentally, of course, and the ability to reduce the amount of such ambient moisture within the atmosphere of a manufacturing location is extremely difficult and costly. Even small amounts (again, 20 ppm, as an example) is very difficult to prevent and any amount may, as noted above, cause electrolyte hydrolysis that leads to the troublesome effects described herein. The further presence of water within a target cell may thus continue to cause such problems that cause reduced battery cycle life (capacity retention) over a relatively short period of time (or # of cycles) that would certainly compromise the needs of the industry to provide long cycle life and reduced recycling and/or disposal requirements.

As alluded to above, rather complex and costly free water (and thus transition metal dissolution) mitigation steps have been proposed within the lithium-ion battery area. Such varied approaches include a number of means to scavenge and neutralize water within different components of such cells. For example, one concept has introduced a simple method to enhance cathode lifetime by blending a low-temperature, dehydratable molecular sieve with the cathode active material powder. The benefits of this method include the localization of the water scavenging material within the electrode and the ability to dehydrate the molecular sieve at temperatures that may not degrade other components in an assembled cell. Another idea introduced a water scavenger into a target cell by directly dosing the electrolyte with an additive for such a purpose. Another possible solution introduced a metal organic framework (MOF) with water scavenging capability into a target cell by mixing the MOF powder with polymer binder to create a film to replace the polymer separator. While these water scavenging techniques show clear benefits to cell capacity retention, they come at the sacrifice of higher material cost, more complex production processes, and lower energy density. As a result, such water scavenging alternatives have not been widely adopted to date.

Scientists and economists can both see the benefits of replacing conventional cell components with more environmental options. As a cost-effective renewable and as the most earth-abundant biopolymer, cellulose and its derivative materials have been considered for several sustainable energy systems. Carboxymethyl cellulose (CMC) has already been widely used as a binder option for electrode laminates. Recently, research groups have shown a growing interest in nonwoven, cellulose-based battery separators for their several benefits over conventional separator materials. The composite nonwoven separator can be designed to have improved thermal stability, increasing cell safety. The fibrillation and calendaring process of paper-like, nonwoven separator allows for a tunable pore size, facilitating ionic diffusion and electrolyte uptake. Other developments, at least hypothetically, have concerned noted improved capacity retention as well. In such considerations, improved battery capacity retention has been attributed to improved electrolyte uptake, uniform pore size distribution, high porosity, and/or low membrane resistance of the cellulose-based nonwoven separator. The exact mechanism by which such cellulose-based, nonwoven separators contribute to improved cycle life of lithium-ion batteries (and other like power generating articles and devices), however, remains unresolved as such other developments have yet to provide definitive results.

### Advantages and Brief Description of the Disclosure

A distinct advantage of the present disclosure is the facilitation of a single separator article to provide, simultaneously, proper separator benefits (porosity, mean pore flow sizes, Gurley air resistance, and the like) as well as water scavenging capabilities for cost-effective and reliable provisions of all such characteristics. Another distinct advantage is the ability to provide optimal water scavenging capabilities through the utilization of a majority of cellulosic-based materials therein such a separator coupled with a post-manufacturing heat-treatment (drying) step or steps to accord a maximum amount of free hydroxyl sites at the cellulose constituent surfaces. Yet another advantage of the disclosed battery separator is the ability thereof to scavenge and retain free water to maximum effect within a closed cell lithium-ion battery. Yet another advantage is the provision of optimal water scavenging effects to allow for high durability of the subject lithium-ion battery transition metal constituents in order to accord a significant increase in life cycle measurements thereof. Further advantages of such a disclosed separator pertain to the benefits associates with such water-scavenging capabilities, particularly as they have been determined to impart unexpectedly effective improvements to such rechargeable batteries in relation to early mitigation of hydrofluoric (or other oxidizing materials) within such cells. It has been found, in other words, that such separators as disclosed herein do not only provide effective electrolyte passage and prevention of cathode and anode contact during utilization thereof, but the water-scavenging properties provided at the beginning of cell manufacture allows for early and continuous water removal from such cells, thereby reducing, at least, the potential for hydrolysis of certain electrolyte (and other battery components) to produce even minimal amounts of oxidizing acids, and the like. Such an advantageous result, specifically in relation to a rather simple and straightforward utilization of a specially treated hygroscopic fiber-filled battery separator, allows for significant reductions in internal battery component problems, ostensibly. A result heretofore unexplored and, apparently, not well understood within the rechargeable battery art.

Accordingly, this disclosure pertains to a non-woven lithium-ion battery separator comprising greater than 50% by weight of a cellulosic fiber material, wherein said separator provides sufficient porosity for electrolyte ion transfer therethrough and suitable prevention of electrode contact through at least a single layer thereof of said nonwoven separator, and wherein said non-woven separator exhibits water scavenging subsequent to a heat-treatment procedure of exposure to a temperature which is sufficient to facilitate removal of the water for a time which allows a substantial portion of the water which is generally present to be removed. Thus, a temperature of 105° C. is required, or preferably 110° C., or more preferably 115° C., or most preferably 120° C. Such a temperature must not be so high as to degrade the cellulose, and high temperatures have been shown to degrade the water scavenging capabilities. Thus, the maximum temperature is less than 200° C., or preferably less than 190° C., or more preferably less than 175° C. or even 160° C. The time of exposure is also important and must be long enough to allow the water to evolve out of the separator. Such time will depend on the size and form of the separator and will be longer for large rolls of material than for example for a hand sheet. Such times may be required to be more than 1 hour, or preferably more than 5 hours, or more preferably more than 10 hours or even more than 20 hours. The time also cannot be too long, as degradation of the separator at high temperatures for a long period of time may also occur. Thus, the time of exposure might be less than 96 hours, or preferably less than 72 hours, or more preferably less than 48 hours or even less than 36 hours. The environment of exposure is also important and should include a means of removing moisture from the air. This could be a forced air oven, which could be equipped with a means to remove the moisture from the air. Preferably it could be a vacuum oven, where the vacuum is maintained below a certain pressure, for example less than 100 Torr, or less than 10 Torr, or preferably less than 1 Torr. One particular advantage is that the low moisture content of the dried separator can be maintained if the heating chamber opens directly into a dry room which is maintained with a low dew point. Such a dew point might be lower than 10° C., or less than 0° C., or even less than −10° C. or −20° C. A lithium-ion battery including such a non-woven cellulosic-based insulating separator is likewise encompassed within this disclosure, as is the method of utilizing such a lithium-ion battery to generate electricity in a rechargeable device. Furthermore, a method of manufacturing such a cellulosic-based nonwoven insulating lithium-ion battery separator through a nonwoven fabricating method with a subsequent heat treatment thereof wherein said fabricated nonwoven separator is exposed to a temperature of 110-130° C. for 1-2 hours within an oven is encompassed within this disclosure as well. Such a heat-treated cellulosic-based nonwoven separator exhibits a significant increase in free water scavenging within a closed lithium-ion battery system to prevent (or at least drastically reduce) hydrofluoric acid generation in the presence of a fluorine-containing electrolyte within a closed lithium-ion battery cell.

Additionally, encompassed herein is also a battery cell exhibiting low water content in the electrolyte after significant cycling of the battery. As is well known in the art, very slight degradation of battery electrolytes can cause the formation of water, which will react with the electrolyte to form hydrofluoric acid. The hydrofluoric acid can, in turn, react with oxygen-containing cathode materials to form additional water. This begins a cycle of water forming additional hydrofluoric acid in the electrolyte, with the hydrofluoric acid degrading the cathode to form additional water, which then repeats the cycle. This is the cause of the “knee” in the cycle life shown in FIG. 10, after 2,000 cycles for the control cell. Therefore, this disclosure encompasses an energy storage device comprising a separator, such separator comprising fibers that can be shown to exhibit water scavenging capability above 2 mg/g when tested according to the procedure described herein (and shown in FIG. 5), such separator further heat treated between the temperatures of 100° C. and 200° C. for between 1 and 48 hours without limitation. Such cell, when cycled with a 1C charge and 1C discharge rate for 500 cycles showing less than 5 ppm of water in the electrolyte and maintaining more than 80% of the capacity as exhibited in the first 1C/1C cycle. Such water scavenging capability of the fiber may be more than 2 mg/g, or even greater than 3 mg/g, or preferably greater than 4 mg/g.

Such energy storage device may also exhibit very low water content in the electrolyte after cycling. Such water content may be less than 5 ppm, or less than 2 ppm, or preferably less than 1 ppm or even less than 0.5 ppm. Such cycles may be more than 500 cycles, or more than 1,000 cycles, or preferably more than 2,000 cycles. The capacity maintained after these cycles, when compared to the capacity of the first cycle, may be greater than 60%, or preferably greater than 80%, or even greater than 85% or most preferably greater than 90%.

In preparing the cell, such heat treatment may further comprise maintaining the separator within a dry room from the time it is heat treated until the cell is filled with electrolyte and sealed. Such heat treatment may preferably be at a temperature greater than 110° C., or 120° C. or preferably greater than 125° C. Such heat treatment may further be preferably at a temperature less than 175° C., or less than 160° C. or even less than 150° C. Such heat treatment may preferably be for a time greater than 10 hours, or greater than 15 hours or even greater than 24 hours.

In addition to the cellulosic base of the disclosed separator, there may be included therein other constituents, particularly those that are utilized, at least to some extent, within the lithium-ion battery separator technology. As such, other materials that may be present, with the cellulosic(s) as the predominant (majority) constituent, polymeric components including acrylics such as polyacrylonitrile, polyolefins such as polypropylene, polyethylene, polybutylene and others including copolymers, polyamides, polyvinyl alcohol, polyethylene terephthalate, polybutylene terephthalate, polysulfone, polyvinyl fluoride, polyvinylidene fluoride, polyvinylidene fluoride-hexafluoropropylene, polymethyl pentene, polyphenylene sulfide, polyacetyl, polyurethane, aromatic polyamide, semi-aromatic polyamide, polypropylene terephthalate, polymethyl methacrylate, polystyrene, polyaramid, aramid, and blends, mixtures and copolymers including these polymers. Other possible fibers that may exhibit sufficient water scavenging properties include proteinaceous types, such as, without limitation, ramie, jute, flax, hemp, silk and wool, basically natural hygroscopic fiber types, further including any blends thereof, as well as with cellulose, silk, wool, etc., types. One way to discern a fiber or polymer suitable for absorbing water from an organic electrolyte is to note the natural water uptake from atmosphere, which can be measured according to TAPPI-ANSI T 441 test method. Fibers with water uptake according to this method of more than 3% will be suitable for such water-absorbing separators, or preferably higher than 4%, or more preferably higher than 5% or even higher than 6%. Thus, in the disclosed inventive separators, the cellulose component may be replaced by any fiber with a suitable water uptake, which may include wool, silk or natural protein fibers as well as fibers from other hygroscopic materials and can include fibers that may not be hygroscopic that are subsequently coated with hygroscopic materials. While it is most beneficial to have a large portion of the separator be made from the cellulosic or hygroscopic polymer, it need not be all. Thus, the cellulosic or hygroscopic polymer may make up more than 20% of the separator by weight, or preferably more than 35%, or more preferably more than 50%, or even more than 65% or 75%.

The fiber constituents (again with cellulosic preferably, though not necessarily, as the major amount) may also be pre-treated with adhesives to effectuate a desired degree of contact and dimensional stability of the overall nonwoven structure subsequent to fabrication. The resultant nonwoven structure would thus exhibit suitable uniformity in terms of thickness, porosity, and, most importantly, pore sizes, therein, to not only provide effective water scavenging but appropriate performance as a lithium-ion battery separator, as well. The potential to calendar and otherwise alter the thickness of the resultant nonwoven cellulosic-based lithium-ion battery separator permits a manufacturer the further capability to allow for greater versatility in terms of both air resistance and mean pore size measurements.

Wet-laid and other methods of nonwoven sheet manufacture may also be followed to create the disclosed cellulosic-based disclosed battery separators. Other methods may include, without limitation, carding, cross lapping, hydroentangling, air laid, needlepunch, or other like nonwoven production methods.

Such lithium-ion battery separators as described herein are clearly useful for improving the art of primary and rechargeable batteries, but also may be used for other forms of electrolyte conducting energy storage techniques, such as capacitors, supercapacitors and ultracapacitors, particularly in terms of not only providing effective pore sizes, etc., separator benefits, but also the noted water scavenging characteristics attributable to the cellulosic constituents and heat-treated post-manufacture steps. Such overall benefits thus not only allow significant benefits as separators, but contribute to improvements in the energy loss, power discharge rate, and other properties of these devices in relation to water scavenging capabilities, all in a single separator article. As alluded to above, such a simplified approach within the lithium-ion battery separator art has not been explored to date.

Additionally, however, the manufacturer has other manners of controlling the desired properties of the inventive battery separators through the capability of providing different thicknesses of the cellulosic-based nonwoven separator structure on demand as well. Such a thickness characteristic may be provided through an initial wet-laid (or other type of nonwoven) fabrication method process, and the followed parameters thereof, or the manufacturer may subsequently, as noted above, calendar the resultant fabric to any desired thickness. Such thickness may be less than 250 micrometers, preferably less than 100 micrometers, more preferably less than 50 micrometers, even more preferably less than 35 micrometers, most preferably less than 25 micrometers or even less than 20 micrometers. The capability of preventing contact between the anode and cathode of the battery is necessary to prevent a shorted circuit during battery use; the thickness of the separator and the controlled pore size therein provide a possible essential manner of achieving such a result. Such a pore size may be measured with a porometer in accordance with ASTM F0136 to give the mean flow pore size. The inventive separators will benefit from having a low mean flow pore size, such as lower than 2000 nanometers, or less than 1000 nanometers, or even less than 700 nanometers, or most preferably less than 500 nanometers. However, battery separator thickness may also contribute to the available volume of other component parts within the closed battery cell as well as the amount of electrolyte solution provided therein. The entirety of the circumstances involved thus require an effective separator in terms of multiple variables. The beneficial ease of manufacture as well as the capability of providing effective pore size and air resistance properties, as well as an effective and reliable water scavenging methodology thus sets this development distinctly apart from typical battery separators currently used and marketed today.

Additionally, it should be noted that although a specific cellulosic-based water scavenging nonwoven lithium-ion battery separator is encompassed within this disclosure, the utilization of multiple layers of such a fabric structure, or of a single layer of such a unique battery separator fabric with at least one other layer of a different type of fabric, may be employed and still within the scope of the overall disclosure described herein.

Such cellulosic-based water-scavenging nonwoven lithium-ion battery separators as described herein are clearly useful for improving the art of primary and rechargeable batteries, but also may be used for other forms of electrolyte conducting energy storage techniques, such as sodium-ion batteries, capacitors, supercapacitors and ultracapacitors. Indeed, the overall separator capabilities coupled with the water-scavenging benefits thereof may allow significant improvements in the energy loss, power discharge rate, and other properties of these energy generating and storage devices. It is important, though, that the water scavenging benefits will only be present when the electrolyte does not contain water as an intentional component, and thus the electrolyte may be an organic solvent, or an inorganic liquid. Thus, the water added when mixing or formulating the electrolyte should be less than 1%, or preferably less than 0.1%, or more preferably less than 500 parts per million, or most preferably less than 250 parts per million, or even less than 100 parts per million. The water included in the formulation may even be less than 50 parts per million, or zero.

Overall, then it should be noted that it is well understood that cellulosic materials exhibit a high wettability (wicking capability) with polar solvents that can be attributed to a fibril structure and the presence of many surface-located hydroxyl groups. For reasons mentioned previously, when constructing such a lithium-ion battery water is removed from the nonwoven, cellulose-based separator by heat-treating in an oven, often under a vacuum. Such water removal is both evaporative and chemical in nature. It has been shown that water molecules will react rapidly with cellulose chains either in nanocrystalline cellulose Iα regions outside of the chains or in the amorphous regions, forming hydrogen bonds throughout the structure. As a subject cellulose-based separator is then oven-dried, such hydrogen bonds between the hydroxyl groups and water molecules will often break. The ability to provide such sites for hydrogen bonding at the surface is thus quite important to impart the necessary levels of water scavenging noted herein.

It was believed, without any specific scientific understanding or conclusion, that a cellulosic-based nonwoven separator, after drying, may become a water scavenger at such hydroxyl sites. The exact understanding of such a water-removing mechanism of such a hypothesis was not understood, however, and the ability to optimize such a possible water-scavenging property was sought. Therefore, such a specific water-scavenging mechanism was the focus of such a hypothetical situation, particularly the potential to confirm and identify any such operation of a cellulosic-based nonwoven separator, quantify its water scavenging capability, and correlate its scavenging capability to capacity retention at the cell level.

Even though wicking and wettability of cellulosic-based fabric structures may be well known, the ability to provide a robust battery separator that accords a continued water-scavenging capability over an indefinite period of time within a closed cell was not an evident conclusion. Surprisingly, it was realized that post-manufacturing treatments were needed to effectuate beneficial results in this manner. In particular, the ability to provide a cost-effective methodology without the need for chemical post-manufacturing treatment, and ultimately determining a proper range of heat exposure and times thereof, was highly unexpected. Heat treatments of cellulose fabrics may include any number of temperature ranges and times, certainly, but the ability to optimize surface site generation for moisture wicking purposes has not been evident within the battery separator industry. Additionally, a heat treatment that is too low (e.g., below 100° C., below 80° C., or even below 60° C., as examples) would not open up hydroxyl sites sufficiently and water may remain bonded thereto such hydroxyl groups to a degree that the potential for actually introducing water into a battery through the presence of a cellulosic-based separator treating in such a fashion would be potentially damaging to the target cell. Likewise, higher temperature treatments (e.g., above 150° C., for example) may create carbonyl groups (C═O) instead of opening hydroxyl sites. Such carbonyl groups are ostensibly unreactive in the presence of free water, which would detrimentally reduce the potential for free water scavenging at such a separator surface. Even higher temperatures would most likely lead to weakened tensile strengths of the nonwoven structure which may lead to other problems, as well. As such, it was determined through significant trial and error that the nonwoven cellulosic-based lithium-ion battery separators disclosed herein had to be post-manufacturing heat-treated between 105-200° C. for from 1-96 hours, preferably from 110-190° C. for from 5-72 hours, more preferably from 110-175° C. for 10-48 hours, and most preferably from 110-160° C. for 10-36 hours. Certainly, a lower temperature range may be even more preferred (110-130° C. for 10-32 hours, for instance) for such heat treatments, particularly as it may concern the different types of separator configurations manufactured, including rolls thereof compared with sheets thereof. In any event, with this specific range of temperatures and times (within a standard fabric-treating oven), a maximum amount of hydroxyl sites is generated at the cellulose material of such a disclosed lithium-ion battery separator, thereby allowing for the necessary and desired levels of water-scavenging capabilities described herein.

Such a heat-treatment procedure may be undertaken in various ways. For example, a separator manufacture may produce such a nonwoven cellulose-based separator and either cut specific shapes and sizes thereof or produce a roll thereof for such separation thereafter. Either way, the manufacturer may then subject the nonwoven structure to such a heat-treatment within a closed oven, on a heated conveyor belt, as non-limiting examples. Such heating may be standard ovens or heat sources in such a manner, whether convection, conduction, microwave, or other type of source. Such a heat-treated nonwoven cellulosic-based separator may then be collected as quickly thereafter such heating and then sealed container to best prevent external moisture exposure. Such a sealed separator may then be transported in such a moisture-proof container to a lithium-battery manufacturer for incorporation/installation within a subject cell. Alternatively, or, if desired, in addition to, such a prior drying procedure and sealed transport, a lithium-ion battery cell manufacturer may receive such a nonwoven cellulosic-based separator and subject such an article individually or with other lithium-ion battery components during manufacturing to provide such a heat treatment step for water scavenging purposes. Such a heating possibility may thus utilize standard battery manufacturing ovens or other heating devices as needed.

Importantly, perhaps, is the fact, as noted above, that free water (ambient moisture, for example) within typical environments, and certainly within typical lithium-ion battery (or other like energy generating or storage device) manufacturing locations, is not a trivial or a de minimis issue. Many manufacturing sites have low humidity chambers for manufacturing purposes (basically to reduce environmental moisture at the manufacturing site). Unfortunately, there are still issues with free water presence related to external material manufacture and transport to such sites that may contribute to cell moisture issues. Additionally, electrolytes themselves may exhibit a certain amount of free water due to environmental conditions, as well. As such, it has proven to be very difficult, if not impossible, to reduce if not prevent moisture from entering such closed cell lithium-ion batteries upon production thereof. Thus, it is typical that small amounts of moisture/water are expected within such lithium-ion battery devices as a result of standard environmental conditions. Again, though, some manufacturers may attempt certain steps, including drying a cell prior to actual closing, adding expensive additives, etc., to scavenge moisture therein, and the like, that have proven to be ineffective or costly, at best, it appears. Again, noted previously, such an approach is not the best way to handle such a situation, but, to date, the lack of a suitable and effective moisture reduction step or steps has limited the opportunities for battery component protections from oxidation by hydrofluoric acid (HF) within a closed lithium-ion battery cell.

In response, then, as described herein, a robust approach to protecting such lithium-ion batteries and to ultimately increase the lifetime and life cycle capabilities of such devices is described herein. Such a novel and unique heat-treated cellulosic-based nonwoven lithium-ion battery separator thus provides both standard operations (air flow, pore size, etc.) as well as unexpectedly high levels of water scavenging, all through a cost-effective and reliable manufacturing and post-treatment method. Such a method as described herein is effective with less expensive materials and specific low-cost treatment methods of heating subsequent to manufacture. The resultant nonwoven cellulosic-based separators exhibit a suitable surface area coupled with significant amounts of available reactive sites for water capture at the surface thereof. When present within such closed lithium-ion battery cell, free water appears to easily be removed from the internal environment and any further introduced or generated water is likewise scavenged to the degree that neither the separator nor the overall battery appears to exhibit any compromise in performance levels. To the contrary, the ability of the battery device to exhibit an extended life cycle shows promise related directly to the performance of such a properly heat-treated separator as disclosed and described herein.

Lithium-ion (and other types of rechargeable batteries and/or energy storage devices) are typically made from six primary components: a cathode material, a cathode current collector (such as aluminum foil, although new thin film current collectors may be utilized herein, such as those described within U.S. Pat. Nos. 10,700,339, 10,763,481, 10,854,868, 10,957,956, 11,139,510, 11,158,860, and 11,482,711, all entirely incorporated herein by reference, as described below) on which the cathode material is coated, an anode material, an anode current collector (such as copper foil, or, as for the cathode type, a new thin film material may be utilized herein, as well) on which the anode material is coated, a separator situated between each anode and cathode layer (particularly, in this disclosure the cellulosic-based nonwoven materials described herein), and an electrolyte as a conductive organic solvent that saturates the other materials thereby providing a mechanism for the ions to conduct between the anode and cathode. These materials are provided together in layered format (as in FIG. 6 herein) or, as one non-limiting alternative, wound together into a can, or, as another non-limiting alternative, stacked. There are many other configurations that are and may be utilized for such battery production purposes, including pouch cells, prismatic cells, coin cells, cylindrical cells, wound prismatic cells, wound pouch cells, and the list goes on. These battery- and/or energy-storage cells, when made correctly and handled gently, can provide energy for various applications for thousands of charge-discharge cycles. However, as alluded to above, certain oxidation/dissolution of cathode transition metals may cause battery capacity deficiencies, or, at least, an appreciable, if not significant, reduction in battery cycle life.

As it concerns the cathode materials and structures that may be utilized within the disclosed energy storage device, it has been realized that lithium-ion types are not the sole possibilities. Additionally, as one of ordinary skill in the art should understand, materials including sodium ion, lithium sulfur, LMNO, and the like, and potentially even NiMH and NiCad, may be present for such a purpose. The ability to further utilize recycled lithium materials (from prior lithium batteries) may be employed as well in this situation. The utilization of a proper metallized current collector with such cathode materials is the primary issue, in other words, and such other cathode types should work well for battery safety, effectiveness, and long cycle life benefits as described herein.

Anode materials may include graphite, lithium titanate Li₄Ti₅O₁₂, hard carbon, tin, silicon or mixtures thereof or others as are known in the art, including lithium metal. In addition, anodes which expand and contract to a higher degree may achieve a much longer cycle life. These anodes include, without limitation, silicon, silicon-oxides, tin, tin oxides, lithium metal, lithium metal alloys and other high-capacity anodes for lithium-ion batteries. Some of these, such as silicon, silicon-oxide, tin and others, exhibit very high growth on cell charge and shrinkage on cell discharge. The lower modulus current collectors in this disclosure will be particularly suited to accommodate the dimensional changes in the anode materials, and any others that undergo such severe dimensional change on charge and discharge of the cell. Additionally, for the anode, also included is the concept of an “anode-less” battery, in which the anode is formed by charging the battery, creating a layer of lithium metal on the anode current collector which serves as the anode. In addition, the ion storage material could include those used in other energy storage devices, such as supercapacitors. In such supercapacitors, the ion storage materials will include activated carbon, activated carbon fibers, carbide-derived carbon, carbon aerogel, graphite, graphene, and carbon nanotubes. The coating process can be any coating process that is generally known in the art. Knife over-roll and slot die are commonly used coating processes for lithium-ion batteries, but others may be used as well, including electroless plating. In the coating process, the ion storage material is in general mixed with other materials, including binders such as polyvinylidene fluoride or carboxymethyl cellulose, or other film-forming polymers. Other additives to the mixture include carbon black and other conducting additives.

Other cathode and anode structures may include sodium ion battery types, including, without limitation, sodium phosphate cathode systems, sodium metal, hard carbon, Prussian blue analogues, and layered transition metal oxides.

Counterelectrodes include other electrode materials that exhibit different electrochemical potential measurements from the ion storage materials. In general, if the ion storage material is a lithium-ion anode material, then the counterelectrode would be made from a lithium-ion cathode material; with a sodium ion anode material, the counterelectrode would be manufactured from a suitable sodium ion counterpart, as well. In the case where the ion storage material is a lithium-ion cathode material, then the counterelectrode might be a lithium-ion anode material. In the case where the ion storage material is a supercapacitor material, the counterelectrode can be made from either a supercapacitor material, or in some cases from a lithium-ion anode or lithium-ion cathode material. In each case, the counterelectrode would include an ion storage material coated on a current collector material, which could be a metal foil, or a metallized film such as in this disclosure.

In the layering process, the disclosed electrode is layered with the counterelectrode with the electrode materials facing each other and a porous separator between them. As is commonly known in the art, the electrodes may be coated on both sides, and a stack of electrodes may be formed with the inventive electrode and counterelectrodes alternating with a separator between each layer. Alternatively, as is also known in the art, strips of electrode materials may be stacked as above, and then wound into a cylinder or other wound shape, such as for flat-wound cells.

Packaging materials may include hard packages such as cans for cylindrical cells, flattened hard cases or polymer pouches which may be made from plastic, aluminum, steel, laminated materials or others without restrictions from the known art. In each case, there must be two means of making electrical contact through the case that can be held at different voltages and can conduct current. In some instances, a portion of the case itself forms one means, while a different portion of the case that is electrically isolated from the first portion forms another means. In other instances, the case may be nonconducting, but allows two metal conductors to protrude through the case, often referred to as tabs.

The liquid electrolyte is typically a combination/mixture of a polar solvent and a lithium salt. Commonly used polar solvents include, as noted above, propylene carbonate, ethylene carbonate, dimethyl carbonate, diethyl carbonate, but other polar solvents, including ionic liquids. Lithium salts commonly utilized within this industry include, without limitation, LiPF₆, LiPF₄, LiBF₄, LiClO₄ and others. The electrolyte may also contain additives as are known in the art. In many cases, the electrolytes can be flammable, in which the safety features of the inventive metallized substrate current collectors can be advantageous preventing dangerous thermal runaway events which result in fire and damage both to the cell and external to the cell. It is interesting to note also that the extension of the cycle life of the battery can also be useful with solid electrolytes, as are commonly used in solid state lithium-ion batteries, such as ceramic, garnet, or polymer electrolytes, or composites thereof.

### BRIEF DESCRIPTION OF THE DRAWINGS

FIG. 1 shows a water scavenging test method for the disclosed nonwoven cellulosic-based lithium-ion battery separator and its constituent fibers.

FIG. 2 provides a bar-graph representation of water scavenged by nonwoven separator as a function of varied drying times and temperatures.

FIG. 3 shows a graphical representation of Fourier Transform Infrared (FTIR) spectrophotometer results for separator samples dried at varied temperatures for 24 hours.

FIG. 4 shows a graphical representation of separator sample water scavenging in terms of the mass of water absorbed as a function of separator mass.

FIG. 5 shows a bar-graph representation of various separator materials measurements of water scavenging levels for comparisons.

FIG. 6 shows an exploded view of an inventive rechargeable lithium-ion battery including a disclosed cellulosic-based nonwoven lithium-ion battery separator.

FIG. 7 shows a graphical representation of porosity measurements of a disclosed cellulosic-based nonwoven separator.

FIG. 8 shows a graphical representation of cell capacity comparisons between conventional separator-formed lithium-ion battery cells and those with a disclosed cellulose-based non-woven separator.

FIG. 9 shows a similar graphical representation as FIG. 8 with cells made with exaggerated levels of water content in electrolyte.

FIG. 10 shows another similar graphical representation as FIGS. 8 and 9 with comparative 25 Ah pouch cells made under commercial conditions.

FIG. 11 shows a similar graphical representation as FIG. 10 with comparative 1865 lithium-ion battery cells made under commercial conditions.

### DETAILED DESCRIPTION OF THE DRAWINGS AND PREFERRED EMBODIMENTS

All the features of this disclosure and its preferred embodiments will be described in full detail in connection with the following illustrative, but not limiting, drawings and examples.

### Experimental Methods

### Materials—

Separators were produced herein utilizing non-woven methods and containing cellulose, aramid, and polyester fibers. Other fiber materials that were tested include aramid, polyester, Lyocell processed cellulose, and acrylic. One method followed for such a wet-laid procedure includes the provision of pre-fibrillated microfibers in a pulp-like formulation, comprising, for example, from 50:1 to 10000:1 parts water per part of fiber (again, water alone is preferred, although, if desired, other solvents that permit a wet-laid process and subsequent facilitation of evaporation thereof may be utilized, including, for instance, certain non-polar alcohols). Such pre-fibrillated fibers are in pulp form as a result of the fibrillation procedure, rendering a slurry-like formulation including the above-noted aqueous-based solvent with the resultant pre-fibrillated fibers. This slurry-like formulation is then mixed and heated in hot water to a temperature of at least 60° C., more preferably at least 70, and most preferably at least 80, having a very low concentration of actual fiber solids content therein (i.e., below 1% and as low as less than 0.5% or even less than 0.1% by weight of water or other aqueous-based solvent). This heated dispersion is then subjected to a high shear environment with subsequent placement on a flat surface. Such a surface is sufficiently porous to allow for solvent elution, thus leaving the desired wet-laid nonwoven single fabric layer. Subsequent to such a high-shear mixing step, the resultant dispersion may be fed into the head of a paper machine (of any type that is capable of making light weight sheets without breaking, such as, as merely examples, Fourdrinier, Incline Wire, Rotoformer, and the like, devices). Such light-weight sheets may be produced through controlling the fiber dispersion input in the head end with simultaneously controlled line speed. A set-up wherein no open draws are present (i.e., wherein the wet fiber web is unsupported) is preferred for such a method. In this situation, the high-water level may be alleviated through vacuum means (which is a common step in the paper making industry), at least initially (i.e., to remove surface moisture to a certain level). For the proper thin sheet result, a fine gauge paper making wire is necessary, particularly at a gauge of at most 40 gauge, more preferably at most 80 gauge. The paper (dispersion sheet) width may be accorded any measurement as long as the production speed does not affect the end result and the overall tensile strength (particularly in an isotropic fashion) is not compromised. For efficiency purposes, the line speed may be set within a range of 25 to 1,500 ft/min, more preferably with a minimum of 50, and most preferably 100.

A calendering step utilizing typical devices, such as hard steel rolls, or a combination of a single hard steel roll and a second hard rubber roll, as merely examples, may be employed. The calendaring step may preferentially be heated to a temperature above 200° F. (93.3° C.), preferably above 250° F. (121.1° C.), or even above 300° F. (148.9° C.). Multiple calendering steps may be undertaken as well for such a purpose, if the materials can withstand such activities without any appreciable loss of tensile strength, etc., as noted above, as well.

Subsequent to such manufacturing steps, the resultant nonwoven cellulosic-based separator materials are then subject to a heat-treatment procedure to ensure proper dimensional stability of the materials for utilization as a separator as well as removal of held water molecules (moisture) from hydroxyl groups at the surface thereof. As noted below, such a sheet (or roll) of separator materials these may be introduced within a drying device. Any type of standard drying means may be utilized, including heated steam cans or a hot air oven or a conveyor belt through a heated region of drying machine. Such heating levels are noted above and herein this disclosure, with a range of temperatures from 105 to 200° C. for from 1 to 96 hours, with a preference of about 110-130° C. for 10-32 hours.

Example cellulosic materials include lyocell, rayon and other man-made cellulosic fibers. Other fibers may include natural fibers such as flax, linen, cotton, or wood fibers, which may be processed to produce very small or even nano-sized fibers, such as nanocellulose. As a preferred example, lyocell may be suspended in water and refined using a double-disc refiner or other high-shear refining technique to create nanofibers.

### Water Scavenging Measurement Method—

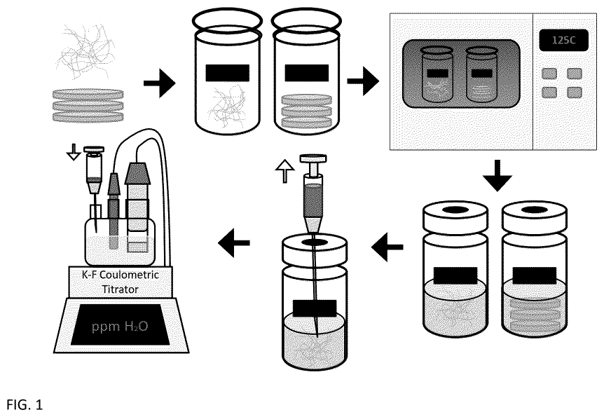

A novel test procedure was developed to quantify the water scavenging capability of the cellulose-based, nonwoven separator or its individual fibers. This test was designed outside of the battery cell environment in order to decouple the scavenging results from complexity and multitude of reactions occurring within an operating cell. FIG. 1 highlights the primary procedural steps to conduct this water scavenging measurement.

First, separator/fiber paper cut into discs using a die, or individual fiber material was weighed to create standardized samples for a comparative study. The samples were then placed in small, open vials for placement within an oven. Samples were then exposed to the oven conditions for varying times and at varying temperatures to investigate the impact of drying conditions.

When samples completed their drying process, the open vials were then pulled from the oven and dosed with a specified amount of battery electrolyte solvent and immediately sealed with a septum cap. The electrolyte solvent used contained measured trace amounts of water for control measurement purposes. Conventional electrolyte solute may react with water and could impact measuring water content, therefore, only the electrolyte solvent was used in relation to the actual representative battery electrolyte. The electrolyte solvent and sample material were left sealed for a specified amount of time before measurements were conducted.

A Karl-Fischer (KF) Coulometric Titrator was used to determine the water content of the electrolyte solvent solution. A syringe with needle was used to puncture the septum of the vial cap and draw a sample of the electrolyte solvent solution that had been exposed to the sample. The syringe with the electrolyte solvent sample was then weighed. The electrolyte solvent sample was then injected into the analyte-containing glassware of the KF Coulometric Titrator. The empty syringe was then weighed to determine the mass of the sample injected. Over time, the water within the electrolyte solvent sample reacted with the KF electrodes until reaching a steady state. The current generated from water electrolysis and the mass of the electrolyte solvent sample was then used by the KF coulometric titrator software to determine water content in parts per million (ppm). This ppm water measurement acted as the key indicator for a sample's water scavenging capability. That is, a vial with only the electrolyte solvent solution and a vial with the same solution and added sample were measured, and their difference indicated how much water the sample has scavenged. With this technique, studies were conducted that probe the following variables: sample mass, fiber type, drying temperature, drying time, and the exposure time between electrolyte solvent and material sample.

### Results

### Water Scavenging Test Method—

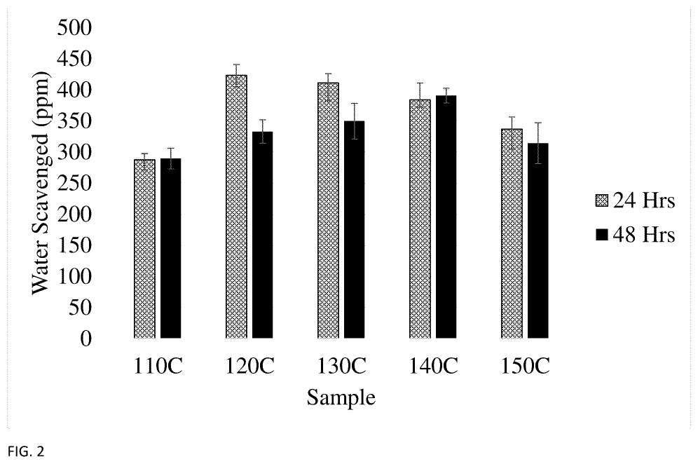

The values in FIG. 2 were calculated by taking a difference between the measured water content from electrolyte solvent that has not been in contact with a sample from electrolyte solvent that has. In each case, the drying temperatures and times are shown in the figure. The amount of solvent used was 5 mL, which was initially doped with 1000 parts per million of water. The amount of fiber or separator was measured close to 150 grams. From FIG. 2, it is shown that as drying temperature is increased, the water scavenging increases then decreases. When looking at drying times, the 24-hour drying time outperformed the 48-hour drying time. This indicated that water scavenging may be optimized by determining the best drying parameters. From the recorded measurements, it is inferred that drying at 120-130° C., around 24 hours would optimize water scavenging in very small quantities of this nonwoven separator. Larger quantities in different configurations would likely require a higher temperature and longer time to reach optimum drying conditions.

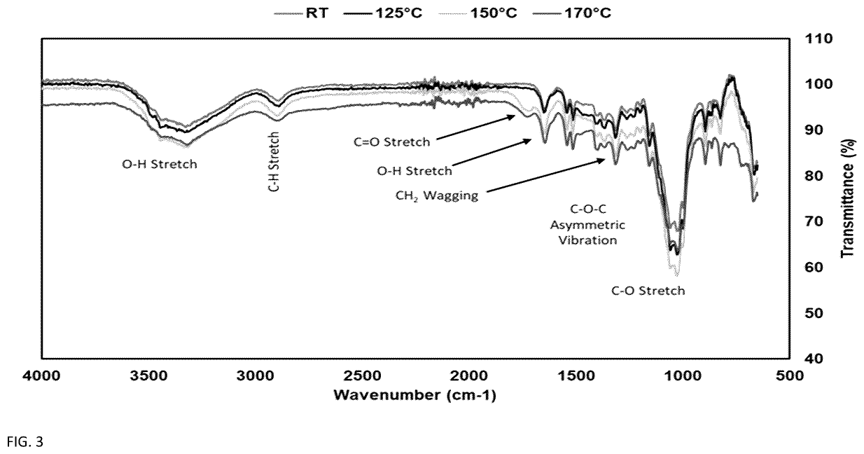

The IR spectra of the cellulose-based separator samples undergoing various heat (drying) treatments were recorded. Separator samples were prepared placing small, punched samples (roughly 2 cm diameter circles) into clean open containers to subject to drying at varying conditions for 24 hours. After heat treatment, the samples would be sealed in their container, allowed to cool, then transferred to measurement within the same day. An Agilent Cary 630 FT-IR Spectrometer with micro-ATR (diamond crystal) was used to obtain FT-IR spectra, sampled within a 4000 to 650 cm-1 range, averaged from 32 scans, and obtained with at least 16 cm-1 resolution. Samples were directly placed on the crystal in lab atmosphere for measurement. Because the separator is highly uniform, sample thickness was assumed to be consistent, confirmed by multiple measurements across each sample, therefore, qualitative peak comparison can be performed from sample to sample. The data in FIG. 3 shows the impact of drying at 125° C., 150° C., and 175° C. as well as a room temperature sample for comparison. The decrease in water scavenging may be explained by a degradation seen in the chemical structure. The FTIR results show that higher temperatures result in a chemical evolution of the separator. Of particular interest is the evolution of cellulose OH groups to C═O groups by transforming into furan type structures through such heat treatments at high temperatures as noted above.

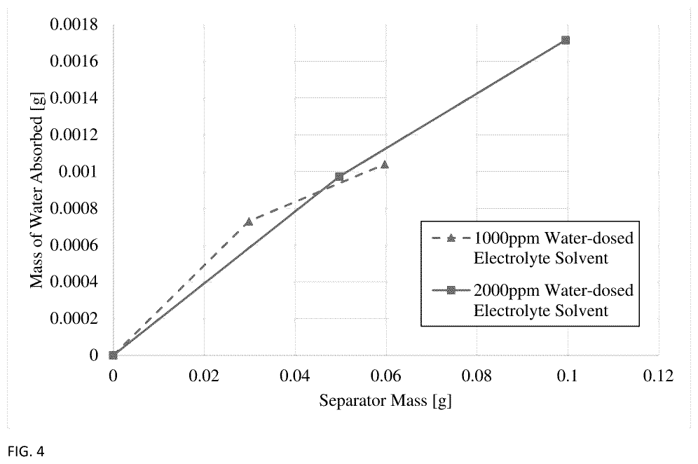

FIG. 4 shows a relatively linear relationship between the mass of water absorbed and mass of separator. Additionally, two electrolyte solvents were tested with varied initial amounts of water (1000 and 2000 ppm). For these tests, the separator was dried at 125° C. for 24 hours and varied amounts of separator were used with 5 mL of electrolyte solvent. Both electrolyte solvents yielded similar water scavenging results. From this data, it is believed that water scavenging is directly related to the amount of separator present, but not affected by higher or lower initial concentrations of water. In this study, higher concentrations of water and higher electrolyte/separator ratios were used than would be seen in most battery assemblies in order to complete the measurements. However, it is understood that drying the separator opens water scavenging “sites”; and once these sites are filled with water, the separator's water scavenging mechanism terminates.

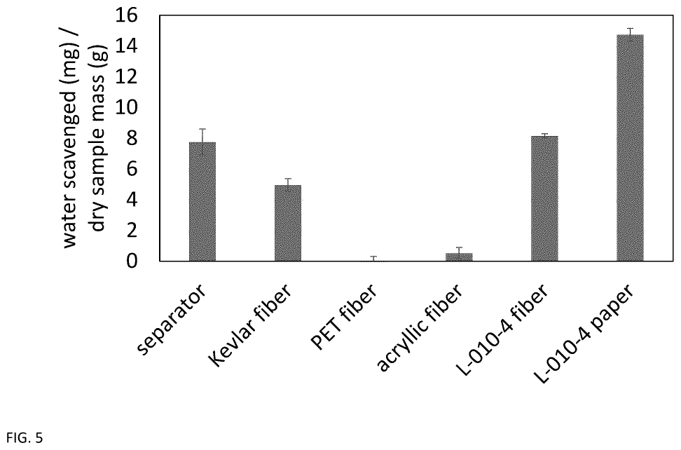

FIG. 5 shows how much water is scavenged by varied material samples including nonwoven separator, aramid (Kevlar), PET, Acrylic, Lyocell cellulose fibers and Lyocell cellulose paper. From this figure, it is clear that Lyocell cellulose is responsible for the water scavenging mechanism inside the nonwoven separator (with aramid also providing water scavenging benefits, as well). The tests in FIG. 5 were performed under the same conditions as those for FIG. 4.

### Heat-Treatment Examples—

### Separator Manufacture Heat Treatments—

In one case, a manufacturer of said cellulose-based separator conducts an appropriate heat/drying treatment to optimize the water scavenging capability. Said manufacturer undertakes the drying steps using a variety of heat sources, such as within a vacuum or within a dry room. To prevent the material from re-absorbing moisture, the manufacturer packs the sheets or rolls of material within a sealed containment with the intention of preventing moisture exposure to the material. Battery manufacturers using the material receive this material within the sealed containment (with manufacturer's recommended instructions for handling. For example, the manufacturer recommends only opening within an appropriate dry, vacuumed, or heated environment with subsequent instructions to minimize possible exposure to moisture by performing assembly in the dry environment or performing assembly and sealing battery containers as quickly as possible.

### Battery Manufacturing Heat Treatment—

Alternatively, as alluded to above, the cell manufacturer is responsible for the appropriate preparation of the materials to optimize the water scavenging feature. That is, the separator manufacturer produces a separator material and transports to the battery (cell) manufacturer under standard procedures. When the material arrives, the cell manufacturer stores the separator material under standard manufacturer-recommended conditions. At the time of cell build, the cell manufacturer conducts the pretreatment process (drying, heat, vacuum, etc). The cell manufacturer is then aware of the need to limit exposure to moisture and to complete the cell assembly process within an appropriate time frame and low-moisture environment (dry room, vacuum, glove box, etc). Other than appropriate pretreatment of the material and then mitigating exposure to moisture, the rest of the battery manufacturing process would be the same.

### Battery Separator Base Analysis and Testing

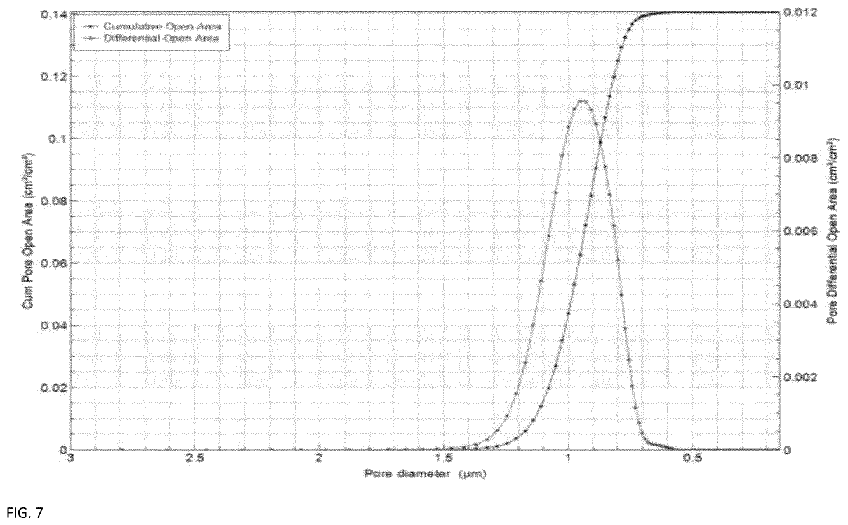

Porosity was calculated according to the method in U.S. Pat. No. 7,112,389, which is hereby incorporated by reference. Results are reported in %, which related to the portion of the bulk of the separator that is filled with air or non-solid materials, such as electrolyte when in a battery. FIG. 7 shows a porosity measurement for a cellulosic-based nonwoven separator as disclosed herein, showing the suitable nature of such a material as a battery separator as it relates to such a characteristic.

Battery separators generally range in thickness from ˜8 microns to over 100 microns. With the high strength, it is likely that a sheet of 12 gsm can be made without difficulty, and calendaring can reduce the thickness such that the full range of useful sheet thicknesses can be made with this technology. For example, a sheet of 12 gsm may have a thickness equal to one half of the sheets made at 25 gsm, or approximately 40 microns. Calendaring or otherwise compressing the sheet may reduce this thickness by 50%, bringing the resultant thickness to 20 microns. Processing improvements may allow even thinner sheets to be made and compressed to even thinner sheets, all of which would be encompassed within the current disclosure.

### Battery Formation and Actual Battery Testing Results

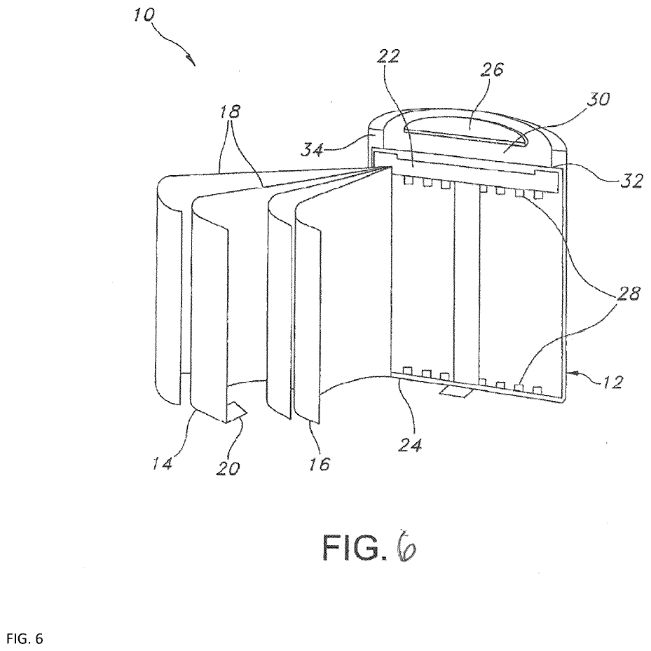

FIG. 6 shows the typical battery 10 structure with the outside housing 12 which includes all of the other components and being securely sealed to prevent environmental contamination into the cell as well as any leakage of electrolyte from the cell. An anode 14 is thus supplied in tandem with a cathode 16, with at least one battery separator 18 between the two. An electrolyte 20 is added to the cell prior to sealing to provide the necessary ion generation. The separator 18 thus aids in preventing contact of the anode 14 and cathode 16, as well as to allow for selected ion migration from the electrolyte 20 therethrough. The general format of a battery cell follows this structural description, albeit with differing structures sizes and configurations for each internal component, depending on the size and structure of the battery cell itself. In this situation, button batteries of substantially circular solid components were produced for proper testing of separator effectiveness within such a cell.

### Life Cycle Testing and Results

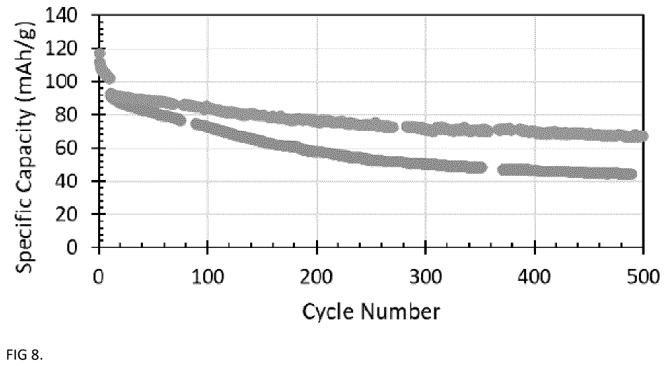

Battery cell cycling was tested for a disclosed cellulose-based separator and typical plastic separators. The tested (inventive and comparative) cells were coin cells (as described above) producing with MSE electrodes (graphite and NMC811). Such cells were charged/formed at C/10 for 10 cycles and then cycled at 1C thereafter. FIG. 8 provides the cycling data are from. The blue color is standard plastic separator. The orange color is cells containing the disclosed (inventive) cellulose-based non-woven separators that have been dried at 125 C for 24 hours. Clearly, the disclosed cells performed significantly better than the typical separator cells.

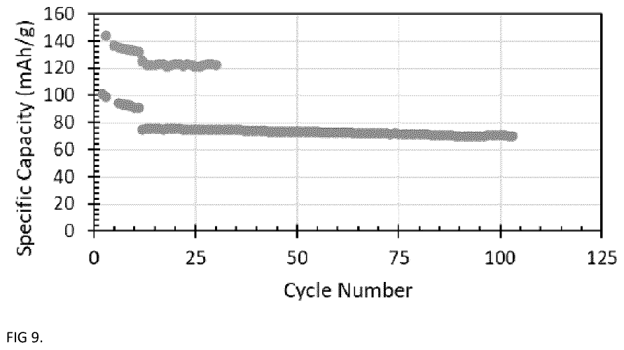

Further testing was undertaken with fewer cycles of coin cells made with conventional and the disclosed cellulose-based non-woven separators (with all other components the same). FIG. 9 shows the divergence of capacity retention between the conventional and non-woven separator cells, particularly in terms of the utilization of a normal electrolyte as such cells actually appears to maintain a similar capacity at the beginning of life, then quickly diverge thereafter. This indicates that the inclusion of a heat-treated cellulose-based non-woven provides effective protections at the initial production of such a cell, appearing to mitigate any potential threats from oxidation of the metal within a cathode component as utilization thereof passes.

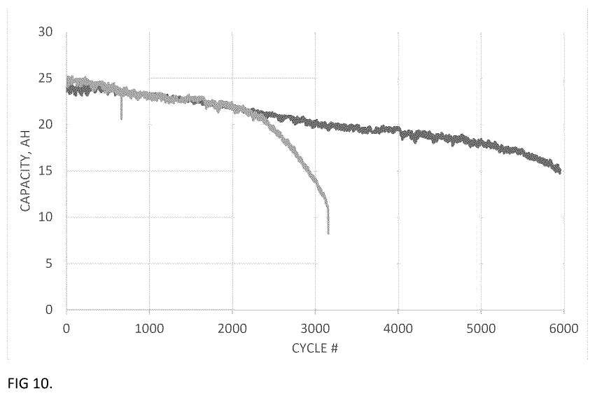

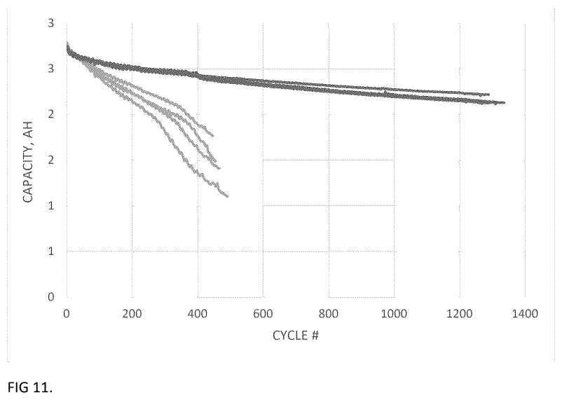

FIGS. 10 and 11 shows the same cycle study formats as above, with FIG. 10 testing coin cells and FIG. 11 directed at 1865 cells (such as disclosed in FIG. 6, above) with disclosed cellulose-based non-woven separators as compared with conventional plastic separators. Such tested cells, however, have been manufactured with an additional 10 ppm of water added to the subject electrolyte. In each type of battery, it is quite evident that that there is a major difference at the beginning of life of the subject cells as it concerns the disclosed cellulose-based separators compared with the conventional plastic ones, indicating that the water-scavenging from the onset of battery production exhibits a capability of a significant impact on improving the robustness of manufacturing in total (in other words, the ability to reduce the capability of a cell of generating water during its lifetime is shown as it is significantly easier to maintain 20 ppm water and rely upon the water-scavenging cellulose-based separator to basically prevent more during battery utilization, as opposed to 1 ppm without any scavenging). Additionally, over time, a cellulose-based separator would most likely degrade much more slowly than such plastic separators.

The above descriptions show the effectiveness of scavenging free water within a cell through the presence and performance of a cellulosic-based nonwoven separator alone, a task heretofore unexplored within the industry. Such a reduction in free water thus reduces propensity of HF production within the cell, thereby reducing the amount of transition metal on the cathode component from dissolution in reaction with any free HF therein. Retention of the structural stability of the cathode thus leads to an increase in battery life. Furthermore, the ability to mitigate HF generation within a cell allows for full complement of electrolyte in use as well as reduction in any chance of a need to further scavenge such an acidic oxidizing agent. Thus, the provision of a water-scavenging component, herein a separator properly produced and treated to provide reactive sites specifically for water capture, allows for the battery cell to be focused on electrical generation and not on HF capture as well.

Furthermore, in actual experimental testing it was realized that the inclusion and thus utilization of such heat-treated cellulose-based separators within lithium-ion batteries exhibited significant capacity increases (improved cycle life) in comparison, at least, with typical separator technology. As such, it is understood that the ability to reduce water from reacting with electrolyte to form HF allows for optimal battery performance overall without the need for further protections and potentially expensive additives, etc., that would not only add to cost, but may contribute to unnecessary increased weight and, to a certain extent, at least, complexity of battery manufacture overall. Such improvements are quite unexpected, permitting simplified and cost-effective approaches to improved cell life cycles that heretofore have been unexplored and misunderstood.

It should be understood that various modifications within the scope of this disclosure can be made by one of ordinary skill in the art without departing from the spirit thereof. It is therefore wished that this disclosure be defined by the scope of the appended claims as broadly as the prior art will permit, and in view of the specification if need be.

What we claim is:

1. A non-woven separator for energy storage devices comprising organic solvent electrolytes, said energy storage device separator comprising greater than 25% by weight of a material that scavenges more than 2 mg/g of water from a test electrolyte containing 1000 ppm of water and wherein said separator provides sufficient porosity for electrolyte ion transfer therethrough and suitable prevention of electrode contact through at least a single layer thereof within an energy storage device.

2. The separator of claim 1 wherein said separator is a nonwoven.

3. The separator of claim 2 wherein said non-woven separator exhibits water scavenging subsequent to a heat-treatment procedure of exposure to a temperature of from 100-200° C. for from 1-96 hours.

4. The separator of claim 1 wherein said separator exhibits a water scavenging capability of greater than 3 mg/g.

5. The separator of claim 2 wherein said separator exhibits a water scavenging capability of greater than 3 mg/g.

6. The separator of claim 3 wherein said separator exhibits a water scavenging capability of greater than 3 mg/g.

7. The separator of claim 3 wherein 3 wherein said separator when present within an energy storage device imparts retention of at least 80% of the first cycle capacity when cycled at a 1C charge and 1C discharge rate for more than 500 cycles.

8. The separator of claim 2 wherein said separator exhibits a water scavenging capability of greater than 4 mg/g.

9. The separator of claim 6 wherein said separator exhibits a water scavenging capability of greater than 4 mg/g.

10. The separator of claim 7 wherein said separator exhibits a water scavenging capability of greater than 4 mg/g.

11. An energy storage device comprising a separator, a current collector, an anode, a cathode, and organic solvent electrolytes, said separator comprising fibers that exhibit water scavenging capability above 2 mg/g, wherein said separator is present between said anode and said cathode, wherein said energy storage device maintains a discharge rate for 500 cycles with a 1C and a 1C discharge rate more than 60% of the capacity as exhibited within the first 1C/1C cycle.

12. The energy storage device of claim 11 wherein said device exhibits less than 5 ppm of water in the electrolyte.

13. The energy storage device of claim 12 wherein said separator exhibits said water scavenging capability subsequent to a heat treatment between the temperatures of 100° C. and 200° C. for between 1 and 48 hours.

14. The energy storage device of claim 13 wherein said separator exhibits said water scavenging capability subsequent to a heat treatment between the temperatures of 100° C. and 200° C. for between 1 and 48 hours.

15. The energy storage device of claim 11 wherein said water scavenging capability of said separator is greater than 3 mg/g.

16. The energy storage device of claim 12 wherein said water scavenging capability of said separator is greater than 3 mg/g.

17. The energy storage device of claim 16 wherein said water scavenging capability of said separator is greater than 4 mg/g.

18. The energy storage device of claim 10 wherein said device exhibits a water content less than 5 ppm after at least 500 cycles of 1C/1C charge/discharge.

19. The energy storage device of claim 18 wherein said device exhibits a water content less than 5 ppm after at least 1,000 cycles of 1C/1C charge/discharge.

20. The energy storage device of claim 19 wherein said device maintains greater than 80% of the capacity of the first 1C/1C charge/discharge cycles.
